(19) United States
(12) Patent Application Publication
(10) Pub. No.: US 2025/0181258 A1
(43) Pub. Date: Jun. 5, 2025

(54) DEFINING STAGED QUANTUM APPLICATIONS COMPOSED OF GRAPH-BASED WORKFLOWS

(71) Applicant: International Business Machines Corporation, Armonk, NY (US)

(72) Inventors: Paul Nation, Yorktown Heights, NY (US); Jay Michael Gambetta, Yorktown Heights, NY (US); Antonio Corcoles-Gonzalez, Mount Kisco, NY (US)

(21) Appl. No.: 18/527,301

(22) Filed: Dec. 3, 2023

(51) Int. Cl. G06F 3/06; G06N 10/60

(52) U.S. Cl. CPC G06F 3/064; G06F 3/0608; G06F 3/0673; G06N 10/60

(57) ABSTRACT

According to an embodiment of the present invention, a method, system, and computer program product are described. An embodiment may receive, by a hybrid computing system comprising a classical computing system and a quantum computing system, a computational problem. The embodiment may map, by the classical system, a portion of the computational problem to quantum blocks and a portion of the computation problem to classical blocks. The embodiment may execute the quantum blocks and classical blocks.

### BACKGROUND

The present invention relates to Quantum Computing, and more specifically, to staging quantum computations.

### SUMMARY

According to an embodiment of the present invention, a method, system, and computer program product are described. An embodiment may receive, by a hybrid computing system comprising a classical computing system and a quantum computing system, a computational problem. The embodiment may map, by the classical system, a portion of the computational problem to quantum blocks and a portion of the computation problem to classical blocks. The embodiment may execute the quantum blocks and classical blocks.

A further embodiment may reorder an order of operation of the classical and quantum blocks to reduce total computation time.

A further embodiment may include the classical blocks and the quantum blocks are reusable code blocks.

A further embodiment may determine a quantum algorithm based on an input data.

A further embodiment may combine blocks based on a computational resource used by the block.

A further embodiment may combine the blocks is based on a condition that it does not extend the total computation time of all of the blocks.

A further embodiment may map using modeling of historical usage to select blocks.

### BRIEF DESCRIPTION OF THE DRAWINGS

FIG. 1 depicts components of a computing system, according to an example embodiment;

FIG. 2a depicts components of a hybrid quantum-classical computing system, according to an example embodiment;

FIG. 2b depicts an example workflow in the hybrid quantum-classical computing system, according to an example embodiment;

FIG. 3 depicts modules of an execution orchestration engine, according to an example embodiment;

FIG. 4 depicts an example workflow of the execution orchestration engine, according to an example embodiment; and

FIGS. 5a and 5b depict an example of how the execution orchestration engine operates, according to an example embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as Execution Orchestration Engine 221. In addition to block 299, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

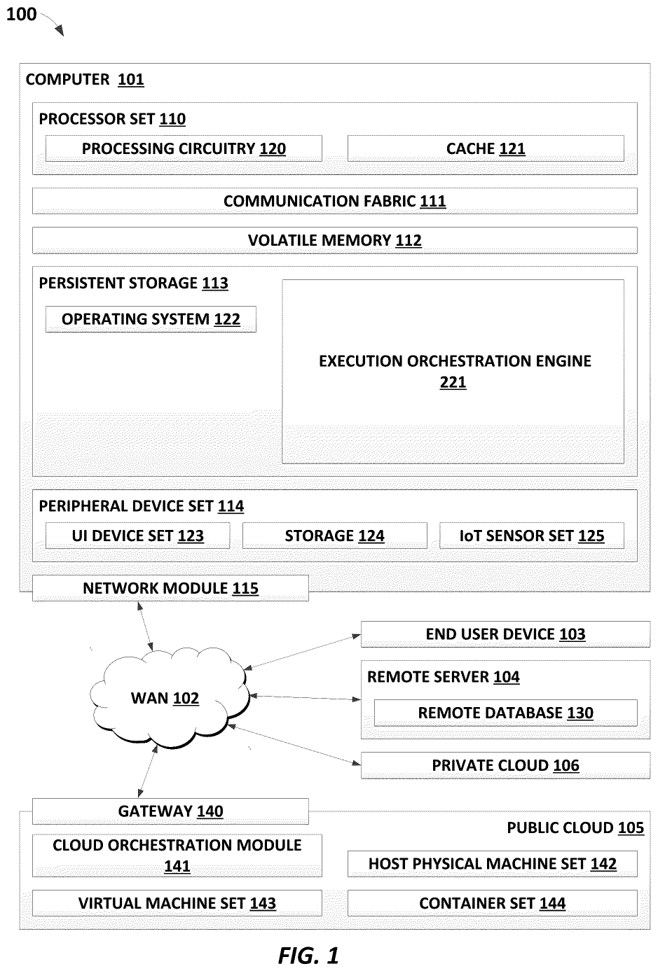

COMPUTER 101 may take the form of a desktop computer, laptop computer, tablet computer, smart phone, smart watch or other wearable computer, mainframe computer, or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

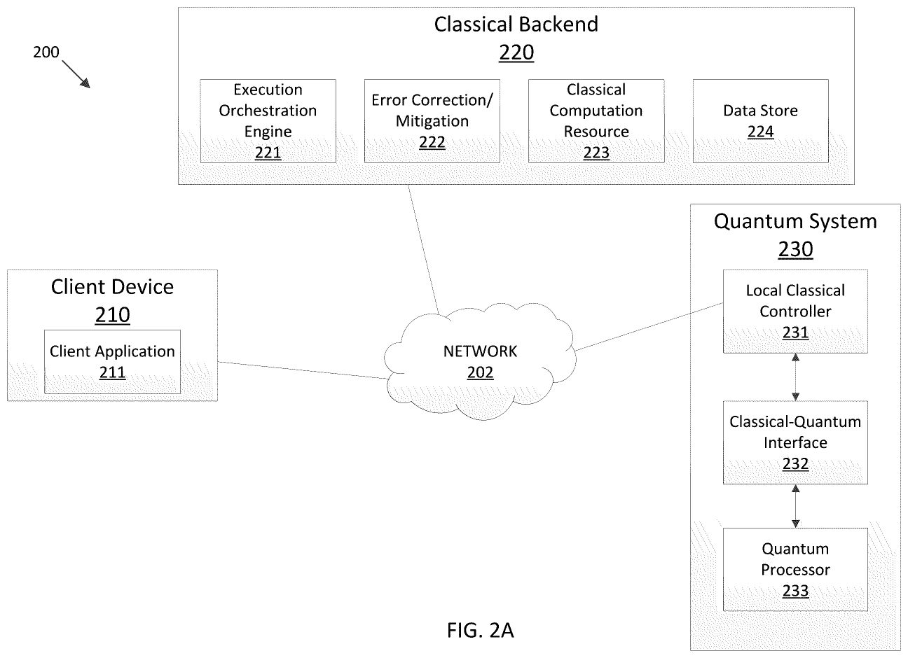

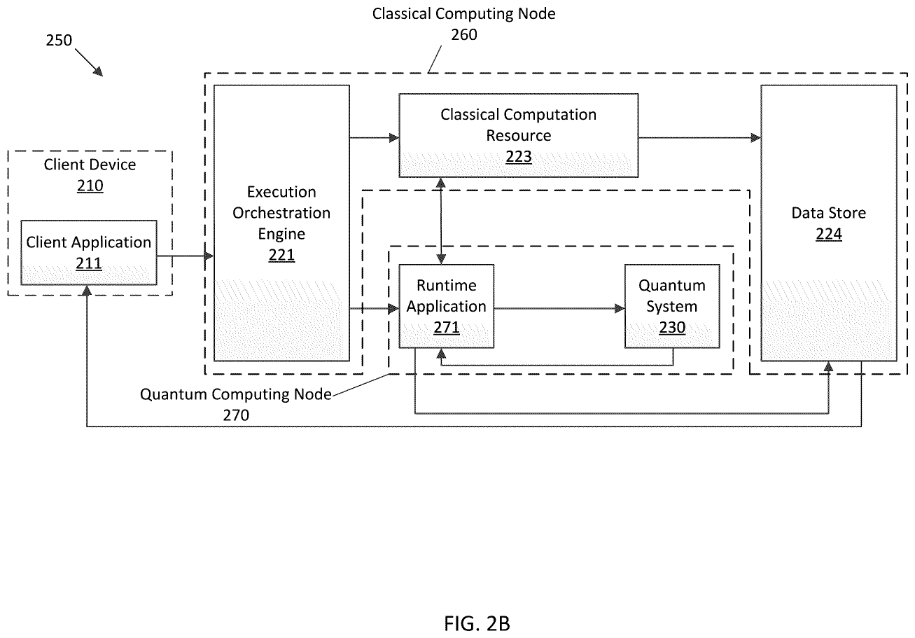

FIG. 2A illustrates a block diagram of an example hybrid computing system 200 that can facilitate execution of a quantum algorithm. As shown, a client device 210 may interface with a classical backend 220 to enable computations with the aid of a quantum system 230.

Network 202 may be any combination of connections and protocols that will support communications between the client device 210, the classical backend 220, and the quantum system 230. In an example embodiment, network 202 may WAN 102.

Client device 210 may be an implementation of computer 101 or EUD 103, described in more detail with reference to FIG. 1, configured to operate in a hybrid computing system 200.

Client application 211 may include an application or program code that includes computations requiring a quantum algorithm or quantum operation. In an embodiment, client application 211 may include an object-oriented programming language, such as Python® (“Python” is a registered trademark of the Python Software Foundation), capable of using programming libraries or modules containing quantum computing commands or algorithms, such as QISKIT (“QISKIT” is a registered trademark of the International Business Machines Corporation). In another embodiment, client application 211 may include machine level instructions for performing a quantum circuit, such as OpenQASM. Additionally, user application may be any other high-level interface, such as a graphical user interface, having the underlying object oriented and/or machine level code as described above.

The classical backend 220 may be an implementation of computer 101, described in more detail with reference to FIG. 1, having program modules configured to operate in a hybrid computing system 200. Such program modules for classical backend 220 may include execution orchestration engine 221, classical computing resource 223, and data store 224.

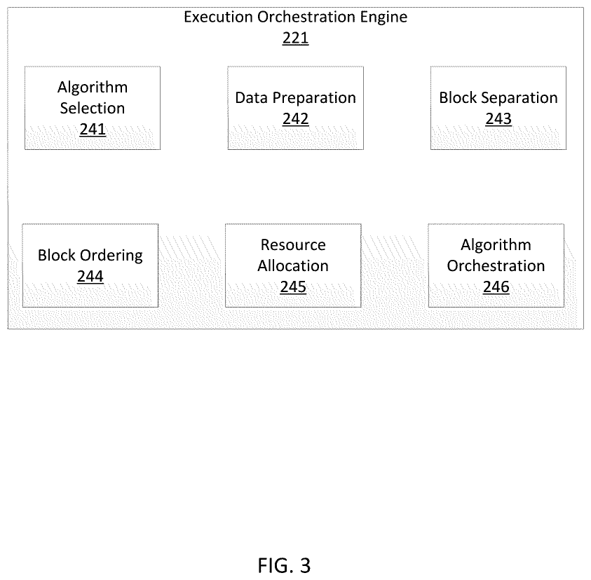

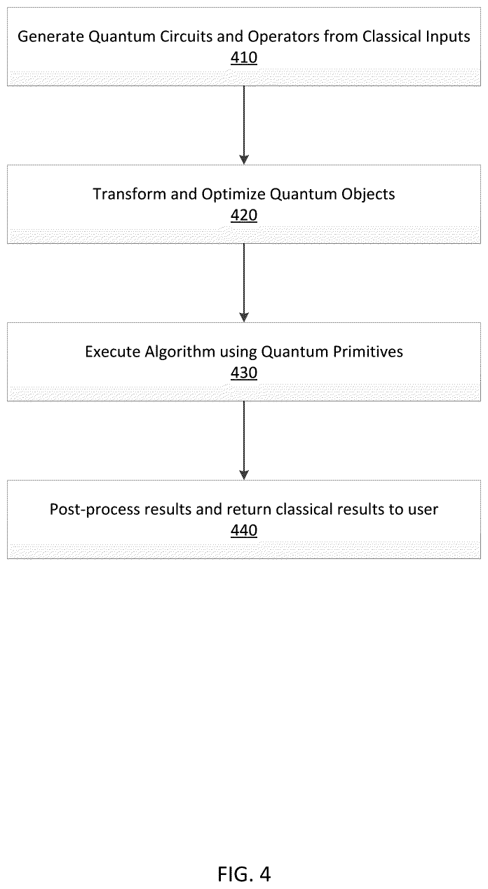

Execution Orchestration Engine 221 may be a program or module capable of preparing algorithms contained in client application 211 for computations using, in whole or in part, quantum system 230. In an example embodiment, as depicted in FIG. 3, Execution Orchestration Engine 221 may be instantiated as part of a larger algorithm, such as a function call of an API. Execution Orchestration Engine 221, using algorithm orchestration 246, may additionally compile or transpile quantum circuits that were contained in client application 211 into an assembly language code for use by the local classical controller 231 to enable the quantum processor 233 to perform the operations of the circuit on physical structures. During transpilation/compilation an executable quantum circuit in a quantum assembly language may be created based on the calculations to be performed, data to be analyzed, and available quantum hardware. In one example embodiment, Execution Orchestration Engine 221, using algorithm selection 241, may select a quantum algorithm or hybrid quantum-classical algorithm from a library of circuits that have been designed for use in a particular problem. In another example embodiment, Execution Orchestration Engine 221 may receive a quantum circuit from the client application 211 and may perform transformations on the quantum circuit to make the circuit more efficient, or to fit the quantum circuit to available architecture of the quantum processor 233. Additionally, Execution Orchestration Engine 221, using data preparation module 242, may prepare classical data from data store 224, or client application 211, as part of the assembly language code for implementing the quantum circuit by the local classical controller 231. Execution Orchestration Engine 221 may additionally set the number of shots (i.e., one complete execution of a quantum circuit) for each circuit to achieve a robust result of the operation of the algorithm. Execution Orchestration Engine 221 may separate the selected algorithms into blocks, using block separation 243, reorder those blocks to improve or enhance performance of the computation, using block ordering 244, and allocate the proper classical or quantum computing resource to perform the algorithm. Further, algorithm preparation 221 may update, or re-compile/re-transpile using algorithm orchestration 246, the assembly language code based on parallel operations occurring in classical computing resource 223 or results received during execution of the quantum calculation on quantum system 230. Additionally, algorithm preparation 221 may determine the criterion for convergence of the quantum algorithm or hybrid algorithm. Execution Orchestration Engine 221 is discussed in more detail below using FIG. 3 and FIG. 4.

Error Correction/Mitigation 222 may be a program or module capable of performing error suppression or mitigation techniques for improving the reliability of results of quantum computations. Error suppression is the most basic level of error handling. Error suppression refers to techniques where knowledge about the undesirable effects of quantum hardware is used to introduce customization that can anticipate and avoid the potential impacts of those effects, such as modifying signals from Classical-quantum interface 232 based on the undesirable effects. Error mitigation uses the outputs of ensembles of circuits to reduce or eliminate the effect of noise in estimating expectation values. Error mitigation may include techniques such as Zero Noise Extrapolation (ZNE) and Probabilistic Error Correction (PEC).

Classical computing resource 223 may be a program or module capable of performing classical (e.g., binary, digital) calculations contained in client application 211. Classical calculations may include AI/ML algorithms, floating point operations, and/or simulation of Quantum operations.

Data store 224 may be a repository for data to be analyzed using a quantum computing algorithm, as well as the results of such analysis. Data store 224 may be an implementation of storage 124 and/or remote database 130, described in more detail with reference to FIG. 1, configured to operate in a hybrid computing system 200.

The quantum system 230 can be any suitable set of components capable of performing quantum operations on a physical system. In the example embodiment depicted in FIG. 2, quantum system 230 includes a local classical controller 231, a classical-quantum interface 232, and quantum processor 233. In some embodiments, all or part of each of the local classical controller 231, a classical-quantum interface 232, and quantum processor 233 may be located in a cryogenic environment to aid in the performance of the quantum operations. In an embodiment, classical backend 220 and quantum system 230 may be co-located to reduce the communication latency between the devices.

Local classical controller 231 may be any combination of classical computing components capable of aiding a quantum computation, such as executing a one or more quantum operations to form a quantum circuit, by providing commands to a classical-quantum interface 232 as to the type and order of signals to provide to the quantum processor 233. Local classical controller 231 may additionally perform other low/no latency functions, such as error correction, to enable efficient quantum computations. Such digital computing devices may include processors and memory for storing and executing quantum commands using classical-quantum interface 232. Additionally, such digital computing devices may include devices having communication protocols for receiving such commands and sending results of the performed quantum computations to classical backend 220. Additionally, the digital computing devices may include communications interfaces with the classical-quantum interface 232. In an embodiment, local classical controller 231 may include all components of computer 101, or alternatively may be individual components configured for specific quantum computing functionality, such as processor set 110, communication fabric 111, volatile memory 112, persistent storage 113, and network module 115.

Classical-quantum interface 232 may be any combination of devices capable of receiving command signals from local classical controller 231 and converting those signals into a format for performing quantum operations on the quantum processor 233. Such signals may include electrical (e.g., RF, microwave, DC), optical signals, magnetic signals, or vibrational signals to perform one or more single qubit operations (e.g., Pauli gate, Hadamard gate, Phase gate, Identity gate), signals to preform multi-qubit operations (e.g., CNOT-gate, CZ-gate, SWAP gate, Toffoli gate), qubit state readout signals, and any other signals that might enable quantum calculations, quantum error correction, and initiate the readout of a state of a qubit. Additionally, classical-quantum interface 232 may be capable of converting signals received from the quantum processor 233 into digital signals capable of processing and transmitting by local classical controller 231 and classical backend 220. Such signals may include qubit state readouts. Devices included in classical-quantum interface 232 may include, but are not limited to, digital-to-analog converters, analog-to-digital converters, waveform generators, attenuators, amplifiers, filters, optical fibers, and lasers.

Quantum processor 233 may be any hardware capable of using quantum states to process information. Such hardware may include a collection of qubits, mechanisms to couple/entangle the qubits, and any required signal routings to communicate between qubits or with classical-quantum interface 232 in order to process information using the quantum states. Such qubits may include, but are not limited to, charge qubits, flux qubits, phase qubits, spin qubits, and trapped ion qubits, or any other suitable qubit structures. The architecture of quantum processor 233, such as the arrangement of data qubits, error correcting qubits, and the couplings amongst them, may be a consideration in performing a quantum circuit on quantum processor 233.

Referring now to FIG. 2B, a block diagram is depicted showing an example architecture, and data transmission, of hybrid computation system 250 employed using a cloud architecture for classical backend 220. Hybrid computation system 250 receives an algorithm containing a computation from a client application 211 of client device 210. Upon receipt of the algorithm and request from client application 211, hybrid computation system 250 instantiates a classical computing node 260 and a quantum computing node 270 to manage the parallel computations. The classical computing node 260 may include one or more classical computers capable of working in tandem. For example, classical computing node 260 may include an execution orchestration engine 261, one or more classical computation resources 223, and a result data store 224. The quantum computing node 270 may include a combination of classical and quantum computing components acting together to perform quantum calculations on quantum hardware including, for example, one or more quantum systems 230. The quantum computing node 270 may include a quantum runtime application 271 and one or more quantum systems 230.

The client application 211 may include programing instructions to perform quantum and classical calculations. In an embodiment, client application 211 may be in a general purpose computing language, such as an object oriented computing language (e.g., Python®), that may include classical and quantum functions and function calls. This may enable developers to operate in environments they are comfortable with, thereby enabling a lower barrier of adoption for quantum computation.

The execution orchestration engine 221 may parse the client application 211 into a quantum logic/operations portion for implementation on a quantum computing node 270, and a classical logic/operations portion for implementation on a classical node 260 using a classical computation resource 223. In an embodiment, parsing the client application 211 may include performing one or more data processing steps prior to operating the quantum logic using the processed data. In an embodiment, parsing the client application 211 may including segmenting a quantum circuit into portions that are capable of being processed by quantum computing node 270, in which the partial results of each of the segmented quantum circuits may be recombined as a result to the quantum circuit. Execution orchestration engine 221 may parse the hybrid algorithm such that a portion of the algorithm is performed using classical computation resources 223 and a session of quantum computing node 270 may open to perform a portion of the algorithm. Quantum runtime application 271 may communicate, directly or indirectly, with classical computation resources 223 by sending parameters/information between the session to perform parallel calculations and generate/update instructions of quantum assembly language to operate quantum system 230, and receiving parameters/information/results from the session on the quantum system 230. Following the parsing of the hybrid algorithm for calculation on quantum computing node 270 and classical computing node 260, the parallel nodes may iterate the session to convergence by passing the results of quantum circuits, or partial quantum circuits, performed on quantum system 230 to classical computing resource 223 for further calculations. Additionally, runtime application 271 may re-parse aspects of the hybrid algorithm to improve convergence or accuracy of the result. Such operation results, and progress of convergence, may be sent back to client device 210 as the operations are being performed. By operating execution orchestration engine 221 in a cloud environment, the environment may scale (e.g., use additional computers to perform operations necessary) as required by the client application 211 without any input from the creators/implementors of client application 211. Additionally, execution orchestration engine 221, while parsing the client application 211 into classical and quantum operations, may generate parameters, function calls, or other mechanisms in which classical computation resource 223 and quantum computing node 270 may pass information (e.g., data, commands) between the components such that the performance of the computations enabled by client application 211 is efficient.

Classical computation resources 223 may perform classical computations (e.g., formal logical decisions, AI/ML algorithms, floating point operations, simulation of Quantum operations) that aid/enable/parallelize the computations instructed by client application 211. By utilizing classical computation resources 223 in an adaptively scalable environment, such as a cloud environment, the environment may scale (e.g., use additional computers to perform operations necessary including adding more classical computation resources 223, additional quantum systems 230, and/or additional resources of quantum systems 230 within a given quantum computing node 270) as required by the client application 211 without any input from the creators/implementors/developers of client application 211, and may appear seamless to any individual implementing client application 211 as there are no required programming instructions in client application 211 needed to adapt to the classical computation resources 223. Thus, for example, such scaling of quantum computing resources and classical computing resources may be provided as needed without user intervention. Scaling may reduce the idle time, and thus reduce capacity and management of computers in classical computing node 260.

Result data store 224 may store, and return to client device 210, states, configuration data, etc., as well as the results of the computations of the client application 211.

Implementation of the systems described herein may enable hybrid computing system 200, through the use of quantum system 230, to process information, or solve problems, in a manner not previously capable. The efficient parsing of the quantum or hybrid algorithm into classical and quantum segments for calculation may achieve efficient and accurate quantum calculations from the quantum system 230 for problems that are exponentially difficult to perform using classical backend 220. Additionally, the quantum assembly language created by classical backend 220 may enable quantum system 230 to use quantum states to perform calculations that are not classically efficient or accurate. Additionally, by decomposing the problem into blocks and optimizing computation of the overall computation between classical and quantum resources, the total time to perform computations, as well as the amount of resources needed, may be reduced. Such improvement may reduce the classical resources required to perform the calculation of the quantum or hybrid algorithm, by improving the capabilities of the quantum system 230.

Referring to FIG. 3, Execution Orchestration Engine 221 is depicted having multiple modules to aid in performing the method described in FIG. 4. At step 410, Execution Orchestration Engine 221 may convert the input into a quantum format using algorithm selection 241 and data preparation 242. At step 420, Execution Orchestration Engine 221 may setup and optimize a quantum algorithm using block preparation 243, block ordering 244, and resource allocation 245. At step 430, may execute the quantum algorithm on quantum hardware using algorithm orchestration 246. At step 440, Execution Orchestration Engine 221 may post-process results from the quantum hardware and return those results to the client application 211.

Algorithm selection 241 may be a program or module that determines a type of computation to perform based on inputs received from client application 211 and/or the data for computation located in data store 224. The inputs may include the problem type (e.g., selection of field by a user or data structure input by the user), the resources the user is willing to allocate to a problem (e.g., the amount of time of use for CPUs, GPUs, and QPUs), and any other computational metric. Algorithm selection module 241 may select from a library of algorithms based on fit between the data and the algorithm, type of data input, as well as the resources to allocate to a problem. In some embodiments, algorithm selection module 241 may select required blocks for a computation (e.g., a specific data transformation and quantum machine learning model, and select additional necessary blocks between them based on dependencies, type of problem, and historical data corresponding to the fit of such algorithms with respect to performance (e.g., accuracy, resource cost). In some embodiments, such historical data may be used to build predictive models to aid in the selection of specific blocks. Additionally, in some cases, the predictive model may help make selections between blocks having similar attributes, such as type of problem and dependency, based on trade-offs between cost and accuracy based on metrics defined by the system or the user. Along with the one or more quantum algorithms, algorithm selection module 241 may select any number of pre-processing, computation, and post-processing elements that can make up the entire computation.

Data preparation 242 may be a program or module that transforms or converts data for computation by the algorithm selected by algorithm selection 241. Such transformation or conversions may include converting data formats to suitable formats.

Block Separation 243 decomposes the algorithms, such as pre-processing algorithms, quantum algorithms, post-processing algorithms, etc. into constituent blocks. Each block may be an independent workflow, such as a function call. After decomposition of the algorithms into blocks, the blocks may be arranged into a graph-based framework. Each Block may contain information about performance of the block, such as type of resource used, historical usage of the block, input and output data from the block, required dependencies, whether the computation is parallelizable, computation types (e.g., chemistry, machine learning, etc.), and any other relevant criterion. In one embodiment, each block may come with a predictive model, based on historical usage of the block, that may be able to estimate the time and resources (e.g., memory, number of operations/second (FLOPS, CLOPS)) required for the performance of the block. Such information may assist mapping blocks during algorithm selection 241, or during block ordering 244 and resource allocation 245.

Block Ordering 244 may determine an order or performance of the blocks after decomposition. Block ordering may be based on a dependency graph for the overall operation, which may either be set based on the library of operations or be created based on the characteristics of the blocks. For example, block ordering may be fill in space between required blocks based on required dependencies of the required blocks, as well as any model based on historical performance metrics for each block, or combination of blocks, together.

Resource Allocation 245 may determine how to group blocks for performance on CPUs, GPUs, QPUs, or any other computing platform. Resource allocation 245 may group blocks together to form a computation unit. The computation unit may be multiple sequential, or parallel, blocks that may be sent to a single resource for computation. For example, multiple classical computing blocks may be merged together to create a computation unit, which may be sent as a single operation to the cloud which may reduce overall computation costs by reducing data transfers across virtual machines and may enable a serverless architecture for these computations.

Algorithm Orchestration 246 may coordinate performance of each of the blocks across multiple computing systems. Additionally, to the extent that any branches, loops, or other conditions that can only be determined at runtime exist, algorithm orchestration 246 may monitor such conditions and route the performance accordingly, or if necessary call other elements of Execution Orchestration Engine 121 to determine additional algorithms, ordering, or allocation needed for obtaining results from the quantum system.

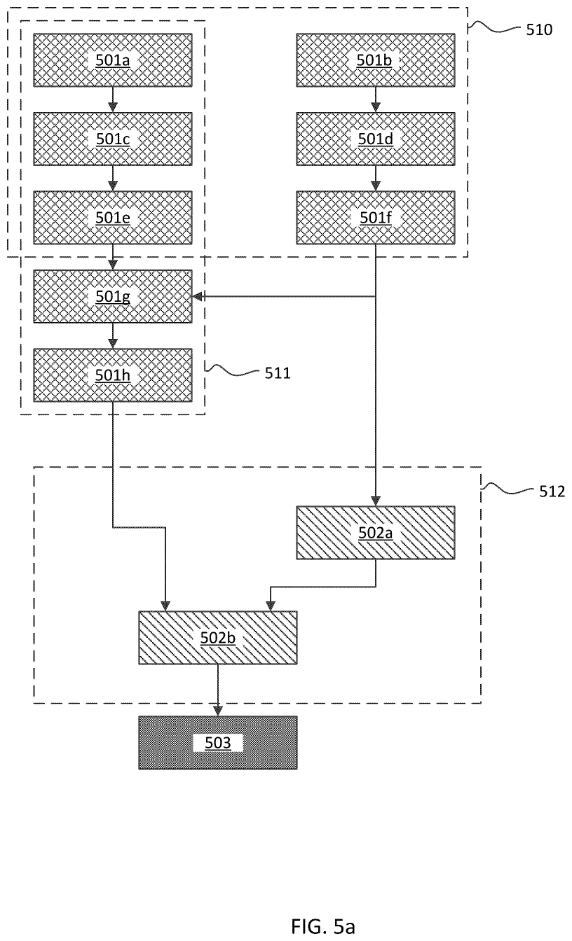

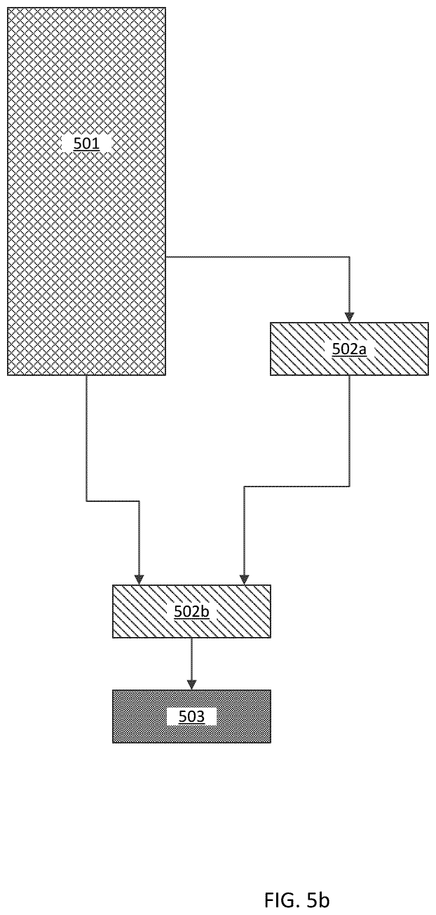

FIG. 5a, an example block ordering and allocation is depicted. In the example diagram, similarly shaded blocks use similar resource types, for example 501a-h may use CPUs, 502a&b may use QPUs, and 503 may use GPUs. In the depicted example, block ordering 244 may create the depicted dependency graph. Following the creation of the graph, resource allocation 245 may look for instances in which a resource type may be combined. For example, resource allocation 245 may look for instances in which similar resource types occur in similar layers, such as illustrated within 510, or in which dependencies use the same resource, such as illustrated within 511 or 512. Once those layers are determined, resource allocation 245 may determine whether to consolidate the block into a single computation based on metrics like timing. In the depicted example, CPU blocks 501a-h may each take 10s of seconds to perform their task, while QPU block 502a may take minutes, and QPU block 502b may take hours. Thus, even though the ordering may allow for merging, QPU block 502a will be kept separate and performed in parallel to the CPU units, as depicted in FIG. 5b. Additionally, in instances where computation can be performed in parallel, additional CPUs, GPUs, or QPUs may be used during the block in order to minimize delays between blocks because a block has multiple dependencies that are required to finish prior to the performance of its block.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method comprising:
receiving, by a hybrid computing system comprising a classical computing system and a quantum computing system, a computational problem;
mapping, by the classical system, the computational problem to computational blocks, wherein each block is an independent workflow of the other blocks, and wherein the computational blocks comprise blocks selected from the group consisting of a quantum block and a classical block; and
executing the quantum blocks and classical blocks.

2. The method of claim 1 further comprising reordering an order of operation of the classical and quantum blocks to reduce total computation time.

3. The method of claim 1, wherein the classical blocks and the quantum blocks are reusable code blocks.

4. The method of claim 1 further comprising determining a quantum algorithm based on an input data.

5. The method of claim 1 further comprising combining blocks based on a computational resource used by the block and historical data about usage of the block.

6. The method of claim 5, wherein combining the blocks is based on a condition that it does not extend the total computation time of all of the blocks.

7. The method of claim 1, wherein mapping further comprises using modeling of historical usage to select blocks.

8. A system comprising one or more processors, one or more computer readable memories, one or more computer readable storage devices, one or more computer-readable storage devices, one or more classical-quantum interfaces, and one or more quantum hardware and program instructions stored on the one or more computer readable storage devices for execution by one or more processors via the one or more computer readable memories to operate the one or more classical-quantum interface to operate the one or more quantum hardware according the program instructions, the program instructions comprising instructions for:
receiving, by a hybrid computing system comprising a classical computing system and a quantum computing system, a computational problem;
mapping, by the classical system, the computational problem to computational blocks, wherein each block is an independent workflow of the other blocks, and wherein the computational blocks comprise blocks selected from the group consisting of a quantum block and a classical block; and
executing the quantum blocks and classical blocks.

9. The system of claim 8 further comprising reordering an order of operation of the classical and quantum blocks to reduce total computation time.

10. The system of claim 8, wherein the classical blocks and the quantum blocks are reusable code blocks.

11. The system of claim 8 further comprising determining a quantum algorithm based on an input data.

12. The system of claim 8 further comprising combining blocks based on a computational resource used by the block and historical data about usage of the block.

13. The system of claim 12, wherein combining the blocks is based on a condition that it does not extend the total computation time of all of the blocks.

14. The system of claim 8, wherein mapping further comprises using modeling of historical usage to select blocks.

15. A computer program product comprising one or more processors, one or more computer readable memories, one or more computer readable storage devices, one or more computer-readable storage devices, and program instructions stored on the one or more computer readable storage devices for execution by one or more processors via the one or more computer readable memories, the program instructions comprising instructions for:
receiving, by a hybrid computing system comprising a classical computing system and a quantum computing system, a computational problem;
mapping, by the classical system, the computational problem to computational blocks, wherein each block is an independent workflow of the other blocks, and wherein the computational blocks comprise blocks selected from the group consisting of a quantum block and a classical block; and
executing the quantum blocks and classical blocks.

16. The computer program product of claim 15 further comprising reordering an order of operation of the classical and quantum blocks to reduce total computation time.

17. The computer program product of claim 15, wherein the classical blocks and the quantum blocks are reusable code blocks.

18. The computer program product of claim 15 further comprising determining a quantum algorithm based on an input data and historical data about usage of the block.

19. The computer program product of claim 15 further comprising combining blocks based on a computational resource used by the block.

20. (canceled)

21. The method of claim 1, wherein mapping further comprises ordering blocks along a dependency graph based on required dependencies of the blocks.
